(19) United States
(12) Patent Application Publication
(10) Pub. No.: US 2004/0239326 A1
(43) Pub. Date: Dec. 2, 2004

(54) Magnetic resonance device comprising a mobile gradient coil unit

(76) Inventor: Ludwig Kreischer, Dormitz (DE)

Correspondence Address: SCHIFF HARDIN, LLP, PATENT DEPARTMENT, 6600 SEARS TOWER, CHICAGO, IL, 60606-6473, US

(21) Appl. No.: 10/487,479

(22) PCT Filed: Aug. 12, 2002
(86) PCT No.: PCT/DE02/02957

(30) Foreign Application Priority Data
Aug. 23, 2001 (DE) 101 41 405.6

(51) Int. Cl. G01V 3/00

(52) U.S. Cl. 324/318

(57) ABSTRACT

A magnetic resonance apparatus has a gradient coil unit, which can be displaced on a guide device disposed inside an examination chamber of the magnetic resonance apparatus, an auxiliary device that is displaceable in relation to the examination chamber, and which can be docked on the guide device in order to extend the displacement of the gradient coil unit. The extension device may continue the course of the guide device along a curved path outside of the examination chamber. A positioning device may be displaced on the guide device, extended by the extension device, to displace a subject relative to the examination chamber.

### BACKGROUND OF THE INVENTION

1. Field of the Invention

The present invention relates to a magnetic resonance imaging apparatus, of the type having a mobile (movable) gradient coil unit.

2. Description of the Prior Art

Magnetic resonance is a known technique for generating images of the inside of a body of an examination subject. For this purpose, rapidly switched gradient fields are superimposed onto a static basic magnetic field in a magnetic resonance apparatus, the static basic magnetic field being generated by a basic field magnet. The magnetic resonance apparatus also has a radio-frequency system which irradiates radio-frequency signals into the examination subject in order to trigger magnetic resonance signals and which accepts the triggered magnetic resonance signals. Magnetic resonance images are produced on the basis of the magnetic resonance signals.

The magnetic resonance apparatus has an examination chamber in which a port of the examination subject to be imaged is positioned for producing magnetic resonance images of the area to be imaged. For this purpose, the magnetic resonance apparatus normally has at least one movable positioning device on which the examination subject is borne. Positioning of the area to be imaged in the examination chamber is possible by displacing the positioning device with the examination subject thereon.

For example, U.S. Pat. No. 5,185,576 discloses a local gradient coil unit that is combined with a local radio-frequency antenna. The local gradient coil unit has an integrated local radio-frequency antenna is configured for a specific area of the examination subject such as a head of a patient. In contrast to a firmly installed gradient coil system which is dimensioned for the entire patient, the local gradient coil unit, therefore, can be smaller which has advantages concerning obtainable gradient intensities and power requirements with respect to a gradient amplifier feeding the gradient coil unit. The local gradient coil unit having an integrated local radio-frequency antenna can be mounted on the positioning device such that the local gradient coil unit does not move toward the positioning device even given the operation of the magnetic resonance apparatus and the forces acting on it.

Furthermore, U.S. Pat. No. 5,311,134 discloses a magnetic resonance apparatus having a cylindrical stationary base unit with a basic field magnet and a gradient coil system that cannot be displaced vis-a-vis the basic field magnet. The magnetic resonance apparatus has a track-like guiding device which is partially arranged in a hollow space of the base unit, and extends beyond the hollow space and on which an essentially cylindrical movable gradient coil unit can be displaced, whereby an antenna unit is firmly connected to it in one embodiment. The magnetic resonance apparatus also has a patient bed with which the patient thereon cannot only be positioned in the hollow space of the base unit but also in a hollow space of the gradient coil unit.

### SUMMARY OF THE INVENTION

An object of the invention is to provide an improved magnetic resonance apparatus having a mobile gradient coil unit wherein the gradient coil unit can be handled in a simple manner.

This object is achieved in accordance with the present invention in a magnetic resonance apparatus has a gradient coil unit, which can be displaced on a guide device disposed inside an examination chamber of the magnetic resonance apparatus, an auxiliary device that is displaceable in relation to the examination chamber, and which can be docked on the guide device in order to extend the displacement of the gradient coil unit. The extension device may continue the course of the guide device along a curved path outside of the examination chamber. A positioning device may be displaced on the guide device, extended by the extension device, to displace a subject relative to the examination chamber.

The inventive gradient coil unit, whose weight can be up to 250 kg, does not have to be lifted for inserting or removing the gradient coil unit into or from the examination chamber given a change between an image acquisition operation with or without the mobile gradient coil unit. Since the gradient coil unit does not have to be lifted, a crane or lift, which is usually provided therefor, is not necessary. Rather, the change can occur by smoothly displacing the gradient coil unit on a horizontal plane.

In an image acquisition operation without the movable gradient coil unit, the gradient coil unit can be positioned next to an opening of the examination chamber such that a maximum extension of a positioning device through this opening is not impaired. Furthermore, additional space behind the opening is not necessary since the gradient coil unit is parked next to the opening—in contrast to the positioning device that is maximally extended through the opening. Therefore, the minimum distance between the opening and the wall of a setup room or a shielding cabin facing the opening is not enlarged. The unimpaired maximum extension of the positioning device is particularly important with for angiography of peripheral vessels of a patient and/or for obtaining images of the entire body, given magnetic resonance apparatuses having a short basic field magnet, in particular. In the inventive apparatus, in particular, the examination chamber can be easily accessed.

In an embodiment, an enlarged space must be provided behind the opening for a maximum extension of the positioning device through the opening of the examination chamber when the gradient coil unit is not used at the same time, however, a guiding device that is arranged in the examination chamber is used not only for the positioning device but also for the gradient coil unit.

### DESCRIPTION OF THE DRAWINGS

FIG. 1 shows a horizontal longitudinal section through a magnetic resonance apparatus having an extension device for a guiding device of a movable gradient coil unit in accordance with invention.

FIG. 2 shows a horizontal longitudinal section through a magnetic resonance apparatus having a curved additional device for a guiding device of a movable gradient coil unit in accordance with invention.

FIG. 3 and FIG. 4 show horizontal longitudinal sections through a magnetic resonance apparatus having a movable auxiliary device for a movable gradient coil unit in accordance with the invention.

FIG. 5, FIG. 6 and respectively FIG. 7 show horizontal longitudinal sections through a magnetic resonance apparatus having a pivotable auxiliary device for a mobile gradient coil unit in accordance with the invention.

### DESCRIPTION OF THE PREFERRED EMBODIMENTS

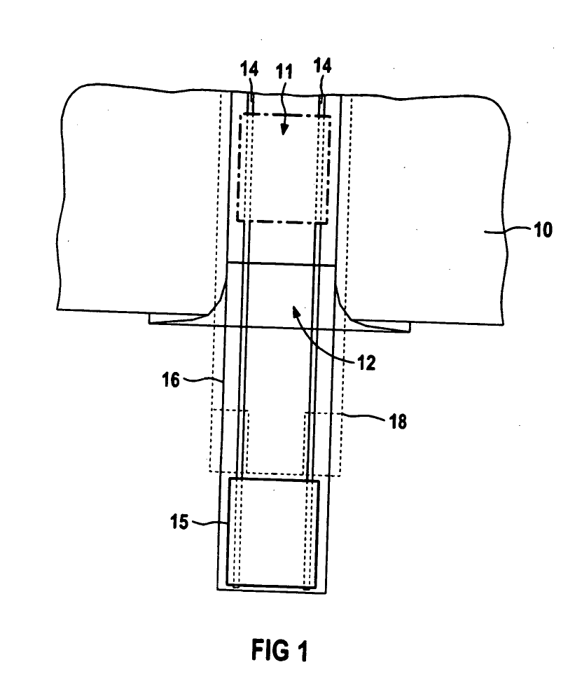

As an exemplary embodiment of the invention, FIG. 1 shows a horizontal longitudinal section through a magnetic resonance apparatus having an extension device 16. The magnetic resonance apparatus has an essentially cylindrical base unit 10 in whose hollow space an examination chamber 11 is arranged. The base unit 10 has a superconducting basic field magnet in order to generate a static basic magnetic field, a firmly installed gradient coil system in order to generate gradient fields and an antenna system, which is also firmly installed, for transmitting radio-frequency signals and for receiving magnetic resonance signals.

The magnetic resonance apparatus has a movable positioning device 18 for introducing the examination subject into the examination chamber 11. The positioning device 18 can be completely moved out of the examination chamber 11 through an opening of the hollow space situated opposite an opening 12 (not shown in FIG. 1) and can be moved from there into the examination chamber 11 and can be maximally extended through the opening 12 up to the position shown in broken lines.

A guiding device 14, which is continued beyond the examination chamber by the extension device 16, is arranged in the examination chamber 11 of the magnetic resonance apparatus. The guiding device 14 and the extension device 16 serve as a glide path for the positioning device 18 and serve the purpose of guiding a movable gradient coil unit 15 on a horizontal plane prescribed by the devices 14 and 16.

In order to generate gradient fields, the movable gradient coil unit 15 has at least one or up to three gradient coils and, depending on the utilization requirements, possibly has shielding coils, cooling and shim devices, which belong to the gradient coils, and can be combined with a local radio-frequency antenna. The electric connecting lines and, if present cooling supply lines, which are necessary for supplying the gradient coil unit 15, are flexibly fashioned and are firmly connected to the gradient coil unit 15 and to a stationary part of the magnetic resonance apparatus.

The movable gradient coil unit 15 is cylindrically fashioned such that it can accept a head of a patient. For this purpose, the positioning device 18 is fashioned at the plane facing the gradient coil unit 15 such that it can be moved into a hollow space of the gradient coil unit 15 so that a patient correspondingly positioned on the positioning device 18 can be introduced with the head into the gradient coil unit 15 by displacing the positioning device 18.

Given an image acquisition operation of the magnetic resonance apparatus without the gradient coil unit 15 and, as shown in FIG. 1, given a positioning device that is maximally extended through the opening 12, a length of the extension device 16 is selected such that the extension unit 16 is still capable of carrying the gradient coil unit 15 in a position shown by a thick continuous line.

For an image acquisition operation using the gradient coil unit 15 and given a positioning device 18 which is only moderately introduced into the examination chamber 11 or which is completely moved out of the examination chamber 11, the gradient coil unit 15, from the position shown by a thick continuous line, is to be moved into the examination chamber 11 by a horizontal displacing along the extension device 14 and guiding device 16 and is to be fixed in the examination chamber 11 in a position shown by a thick dot-dash line. Subsequently, the head of the patient can be positioned in the gradient coil unit 15 by displacing the positioning device 18 with the correspondingly positioned patient.

In an exemplary embodiment, a local radio-frequency antenna, particularly for a head of the patient, can be introduced into the gradient coil unit 15 and is fashioned such it can be fixed on the positioning device 18, so that the radio-frequency antenna, which is fixed on the positioning device 18 at the plane facing the gradient coil unit 15, can be moved in and out of the gradient coil unit 15, which is positioned in the examination chamber 11, by displacing the positioning device 18.

In a further exemplary embodiment, the gradient coil unit 15 is cylindrically fashioned having two recesses for accepting a head of a patient including his/her shoulders, so that a neck area of the patient can also be accepted instead of only imaging the head. German Patent 198 29 298 C2 describes such a gradient coil, however, it is not movable.

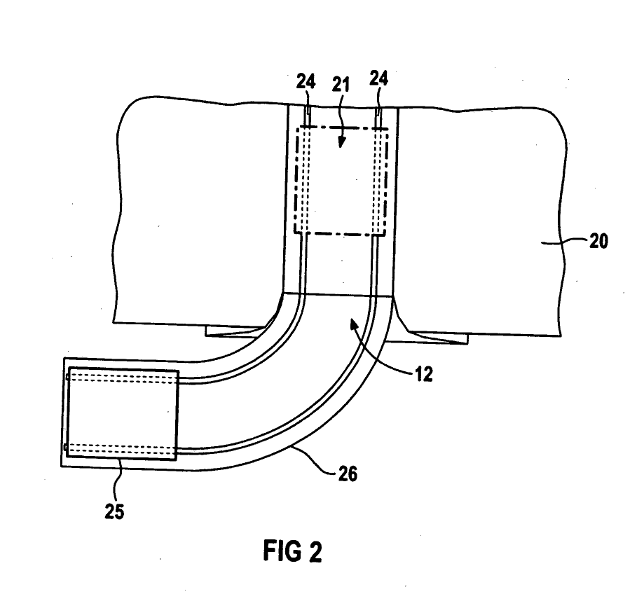

As another exemplary embodiment of the invention, FIG. 2 shows a horizontal longitudinal section through a magnetic resonance apparatus having a curved additional device 26. The magnetic resonance apparatus has an essentially cylindrical base unit 20 that is configured corresponding to the one as shown in FIG. 1. An examination chamber 21 is arranged in a hollow space of the base unit 20, whereby examination chamber 21 has a guiding device 24 for guiding a mobile gradient coil unit 25 within the examination chamber 21. For the continuation of the guiding device 24, the curved additional device docks on an opening 22 of the examination chamber 21 so that the mobile gradient coil unit 25 can be displaced on a horizontal plane defined by the additional device 24 and guiding device 26.

For an operation of the magnetic resonance apparatus by using the movable gradient coil unit 25, the gradient coil unit 25 is positioned as shown by a thick dash-dot line and is correspondingly fixed. For an operation without the gradient coil unit 25, the gradient coil unit 25 is positioned as shown by a thick continues line and is correspondingly arrested. The additional device 26, in particular, is fashioned such that a displaceable positioning device (not shown), which is moved inside through an opening of the hollow space (not shown) that is opposite the opening 22, can be maximally extended through the opening 22 without impairment by the additional device 26.

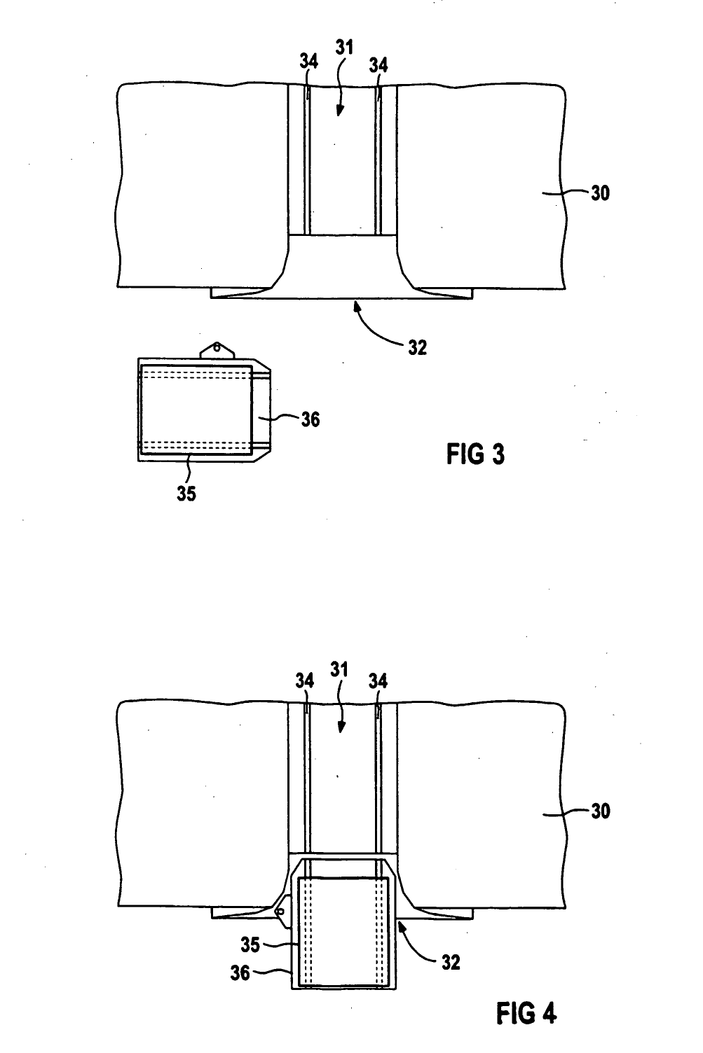

As a further exemplary embodiment of the invention, FIG. 3 and FIG. 4 show horizontal longitudinal sections through a magnetic resonance apparatus having an auxiliary device 36. The magnetic resonance apparatus has an essentially cylindrical base unit 30 that is fashioned as shown in FIG. 1. An examination chamber 31 is arranged in a hollow space of the base unit 30, whereby said examination chamber 31 has a guiding device 34 for guiding a movable gradient coil unit 35.

In FIG. 3, the gradient coil unit 35 is fastened at the mobile auxiliary device 36 and the auxiliary device 36, including the gradient coil unit 35, is parked next to an opening 32 of the hollow space, so that the magnetic resonance apparatus can be operated without the gradient coil unit 35 and without impairment by the gradient coil unit 35. Given this operating state, a positioning device (not shown) can be moved into and out of the examination chamber 31 without being restricted by the gradient coil unit 35. The mobile auxiliary device 36 is fashioned such that it can be attached to the guiding device 34 for inserting or removing the gradient coil unit 35, so that the gradient coil unit 35 can be displaced along a horizontal plane defined by the guiding device 34 and the auxiliary device 36.

FIG. 4 shows the auxiliary device 36 being docked onto the guiding device 34. After the gradient coil unit 35 has been detached with the auxiliary device, the gradient coil unit 35 can be moved onto the guiding device 34 into the examination chamber 31 smoothly by hand or motor-driven by the auxiliary device 36 and can be fixed there in a prescribed position.

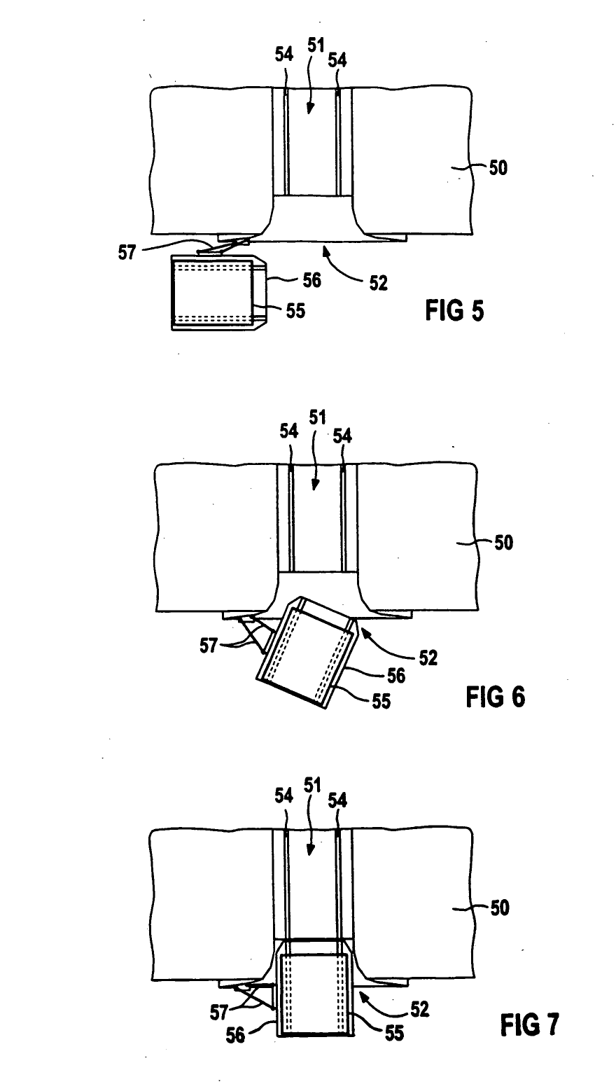

As a further exemplary embodiment of the invention, FIG. 5 to FIG. 7 show horizontal longitudinal sections through a magnetic resonance apparatus having a pivotable auxiliary device 56. The magnetic resonance apparatus has an essentially cylindrical base unit 50 that is fashioned as shown in FIG. 1. An examination chamber 51 is arranged in a hollow of the base unit 50, whereby said examination chamber 51 has a guiding device 54 for guiding a mobile gradient coil unit 55. The magnetic resonance apparatus also has a pivotable auxiliary device 56, which for pivoting about a vertical axis, is connected to the base unit 50 via a hinge 57. The gradient coil unit 55 can be fastened at the auxiliary device 56. The auxiliary device 56 is fashioned in a pivotable manner such that the auxiliary device 56 can dock on the guiding device 54 in order to continue said guiding device 54 so that the gradient coil unit 55 can be displaced on a horizontal plane that is defined by the auxiliary and guiding device 54 and 56. A particular advantage of the pivotable auxiliary device 56 is that the electric connecting lines, which are necessary for supplying the gradient coil unit 55 and possibly cooling supply lines, can be fashioned in a short manner.

FIG. 5 shows the auxiliary device 56, which has the gradient coil unit 55 docked onto it, in a position pivoted next to an opening 52 of the hollow. This position is typical when the magnetic resonance apparatus is operated without using the gradient coil unit 55. A positioning device (not shown), for example by using the guiding device 54, can be displaced in the examination chamber 51 without impairment by the gradient coil unit 55.

The auxiliary device 56 having the gradient coil unit 55 docked onto it, must be pivoted in the direction of the examination chamber 51 in order to operate the magnetic resonance apparatus with the gradient coil unit 55. As an example, FIG. 6 shows an intermediate position of the pivot motion.

FIG. 7 shows the completed pivot motion with the auxiliary device 56 being docked onto the guiding device 54. After the lock has been released, the gradient coil unit 55, proceeding from the auxiliary device 56 can glide onto the guiding device 54, can be displaced when gliding into the examination chamber 51 and can be fixed in the examination chamber 51 in order to subsequently operate the magnetic resonance apparatus with the gradient coil unit 55.

Although modifications and changes may be suggested by those skilled in the art, it is the invention of the inventor to embody within the patent warranted heron all changes and modifications as reasonably and properly come within the scope of his contribution to the art.

I claim as my invention:

1-15. (cancelled)

16. A magnetic resonance apparatus comprising:
a magnetic resonance scanner having an examination volume adapted to receive an examination subject therein;
a guide device disposed in said examination chamber;
a gradient coil unit mounted on and displaceable along said guide device in said examination chamber; and
an auxiliary device that is displaceable relative to said examination chamber, said auxiliary device being attachable by docking to said guide device to extend a displacement range of said gradient coil unit.

17. A magnetic resonance apparatus as claimed in claim 16 wherein said gradient coil unit is fastenable at said auxiliary device.

18. A magnetic resonance apparatus as claimed in claim 16 wherein said auxiliary device is displaceable.

19. A magnetic resonance apparatus as claimed in claim 16 wherein said auxiliary device is pivotable.

20. A magnetic resonance apparatus as claimed in claim 19 wherein said auxiliary device is pivotable around a vertical axis.

21. A magnetic resonance apparatus wherein said magnetic resonance scanner has a stationary part, and comprising a hinge connecting said auxiliary device to said stationary part.

22. A magnetic resonance apparatus comprising:
a magnetic resonance scanner having an examination volume adapted to receive an examination subject therein;
a guide device disposed in said examination chamber;
a gradient coil unit mounted on and displaceable along said guide device in said examination chamber; and
an extension device connected to said guide device and extending said guide device in a curved path outside of said examination chamber, and also extending a displacement range of said gradient coil unit.

23. A magnetic resonance apparatus as claimed in claim 22 comprising a positioning device, adapted to receive the patient thereon, said positioning device being displaceable along said guide device.

24. A magnetic resonance apparatus as claimed in claim 22 wherein said examination chamber has two opposite openings, and comprising a positioning device, adapted to receive the patient thereon, said positioning device being displaceable along said guide device from a first of said two opposite openings and said gradient coil unit being displaceable along said guide device from a second of said two opposite openings.

25. A magnetic resonance apparatus comprising:
a magnetic resonance scanner having an examination chamber adapted to receive a patient;
a guide device in said examination chamber;
a positioning device, adapted to receive the patient thereon, said positioning device being displaceable relative to said examination chamber along said guide device;
an extension device connected to said guide device and extending said guide device beyond said examination chamber; and
a movable gradient coil unit displaceable along said guide device and said extension device.

26. A magnetic resonance apparatus as claimed in claim 25 wherein said examination chamber has two opposite openings, and wherein said positioning device is displaceable relative to said examination chamber from a first of said two opposite openings and wherein said gradient coil unit is displaceable relative to said examination chamber from a second of said two opposite openings.

27. A magnetic resonance apparatus as claimed in claim 25 wherein said extension device has a height allowing displacement of said gradient coil when said positioning device is maximally displaced into said examination chamber.

28. A magnetic resonance apparatus as claimed in claim 25 comprising an arrangement for fixing said gradient coil unit in at least one position in said examination chamber.

29. A magnetic resonance apparatus as claimed in claim 25 wherein said guide device is disposed to displace said gradient coil unit in a horizontal plane.

30. A magnetic resonance apparatus as claimed in claim 25 wherein said gradient coil unit is a head coil.
